(19) United States
(12) Patent Application Publication
(10) Pub. No.: US 2026/0346912 A1
(43) Pub. Date: Nov. 5, 2026

(54) METHODS AND APPARATUS FOR A STEER-BY-WIRE STEERING SYSTEM

(71) Applicant: Ford Global Technologies, LLC, Dearborn, MI (US)

(72) Inventors: Sergio Codonesu, Aachen (DE); Oliver Nehls, Düsseldorf (DE); Hannah Eileen Denomme, South Lyon, MI (US); Alexander Ein Waldt, Köln (DE)

(21) Appl. No.: 19/659,373

(22) Filed: Apr. 27, 2026

(30) Foreign Application Priority Data
May 5, 2025 (DE) 102025117074.6

(51) Int. Cl. B62D 6/00; B62D 1/04; B62D 5/00; B62D 15/02

(52) U.S. Cl. CPC B62D 6/002; B62D 1/04; B62D 5/006; B62D 6/008; B62D 15/021

(57) ABSTRACT

The disclosure generally relates to vehicles, and more particularly, to methods and apparatus for a steer-by-wire steering system. An example steer-by-wire (SBW) steering system comprises a road wheel actuator, machine readable instructions, and a controller to execute the machine readable instructions to determine a wheel angle limit of steerable road wheels of a vehicle based on a speed of the vehicle, determine an adjusted wheel target angle based on the wheel angle limit and a wheel target angle associated with the vehicle, and cause the road wheel actuator to steer the steerable road wheels based on the adjusted wheel target angle.

### RELATED APPLICATION

This patent claims priority from DE Patent Application Number 102025117074.6, which was filed on May 5, 2025, and is hereby incorporated by reference in its entirety.

### FIELD OF THE DISCLOSURE

The disclosure generally relates to vehicles, and more particularly, to methods and apparatus for a steer-by-wire steering system.

### BACKGROUND

Conventional vehicle steering systems rely on mechanical linkages between the steering input device and the road wheels, which can introduce packaging constraints, added weight, and limitations in tuning steering characteristics. Steer-by-wire systems replace such mechanical connections with electronic sensing and actuation, enabling greater flexibility in control and improved integration with driver assistance systems.

### SUMMARY

An example steer-by-wire (SBW) steering system comprises a road wheel actuator, machine readable instructions, and a controller to execute the machine readable instructions to determine a wheel angle limit of steerable road wheels of a vehicle based on a speed of the vehicle, determine an adjusted wheel target angle based on the wheel angle limit and a wheel target angle associated with the vehicle, and cause the road wheel actuator to steer the steerable road wheels based on the adjusted wheel target angle.

An example vehicle comprises steerable road wheels, a road wheel actuator coupled to the steerable road wheels, a hand wheel actuator, and controller circuitry configured to determine a wheel angle limit of the steerable road wheels based on a speed of the vehicle, determine an adjusted wheel target angle based on the wheel angle limit and a wheel target angle associated with the hand wheel actuator, and cause the road wheel actuator to steer the steerable road wheels based on the adjusted wheel target angle.

An example non-transitory computer readable storage medium comprises instructions to cause at least one programmable circuit to determine a wheel angle limit of steerable road wheels of a vehicle based on a speed of the vehicle, determine an adjusted wheel target angle based on the wheel angle limit and a wheel target angle associated with the vehicle, and cause a road wheel actuator of the vehicle to steer the steerable road wheels based on the adjusted wheel target angle.

### BRIEF DESCRIPTION OF DRAWINGS

FIG. 1 is a schematic representation of a vehicle with a steer-by-wire (SBW) steering system in accordance with the teachings herein.

FIG. 2 is a flowchart representative of example machine readable instructions and/or example operations that may be executed, instantiated, and/or performed by example programmable circuitry to implement the SBW steering system of FIG. 1.

FIG. 3 is a schematic representation of an adjusted permissible maximum rack and pinion travel.

FIGS. 4A and 4B are schematic representations of the time-dependent courses of various parameters of the SBW steering system of FIG. 1.

FIGS. 5A and 5B are schematic representations of the consideration of an offset in the time-dependent curves of various parameters of the SBW steering system of FIG. 1.

FIG. 6 is a block diagram of an example processing platform including programmable circuitry structured to execute, instantiate, and/or perform the example machine readable instructions and/or perform the example operations of FIG. 2 to implement the SBW steering system of FIG. 1.

In general, the same reference numbers will be used throughout the drawing(s) and accompanying written description to refer to the same or like parts. The figures are not necessarily to scale.

### DETAILED DESCRIPTION

Steer-by-wire steering systems (hereinafter SBW steering systems) are a steering technology that eliminates the direct mechanical connection between the steering wheel and the road wheel. This direct connection is replaced by a hand wheel actuator, which generates feedback torque for the driver on the steering wheel, and a road wheel actuator, which regulates at least one, but typically several, steerable road wheels to the desired position. The feedback torque gives the driver a feeling about the lateral control of the vehicle.

The turning radius of a vehicle is an important metric for customer satisfaction. For example, a small turning radius is advantageous in urban environments. The turning radius is defined by the suspension geometry, the tire size, and the maximum stroke of the rack, among other things. The maximum rack travel is mechanically limited by mechanical end stops to prevent contact between the front wheels and the surrounding body of the vehicle, such as the wheel arches, even in unfavorable dynamic driving situations (e.g., at high vehicle speeds). According to previous approaches, an additional limitation of the rack and pinion travel is specified based on control technology, for example based on a software control system, to ensure tolerance to the mechanical end stops. This protects the mechanical end stops. This ensures that even in the case of fast steering movements or manufacturing tolerances, a change in the position of the rack is not caused in such a way that the mechanical end stops are loaded. As a result, the functionality of the SBW steering system is limited by the control technology input of the maximum permissible rack and pinion travel. For example, the range of achievable rack and pinion positions is limited in terms of the tolerance range specified by the software control at the mechanical end stops.

In one known solution, a steering map is used to determine the desired position of the rack based on the current steering wheel position. The steering map can be selected from a set of steering maps based on vehicle speed, vehicle direction and driver preferences, for example. The steering map can be used to set tunable, maximum rack travel limits for the control of the rack, which depend on the vehicle speed. In addition, the steering map can have different gear ratios between the rack and steering wheel for different vehicle speeds.

Since the permissible steering wheel angle is not adjusted, a change in the tunable, maximum rack and pinion travel limits leads to an inconsistent steering feel in the area of the end stops of the steering wheel, as these ranges conflict with the tunable (e.g., variable) maximum rack and pinion travel limits. This can lead, for example, to self-steering of the steering wheel or to the driver unintentionally causing high loads on components of the SBW steering system by steering into the steering wheel end stops. For example, this does not prevent unwanted contact between the road wheels and the body of the vehicle from occurring in highly dynamic driving situations.

There is therefore a need to eliminate or at least reduce the disadvantages of known methods of operating a SBW steering system for a motor vehicle. There is a need to enable consistent steering behavior of the steering wheel even in dynamic control situations.

According to one aspect, some examples of the disclosure relate to a method for operating a SBW steering system for a vehicle. The SBW steering system includes at least one road wheel actuator, one hand wheel actuator and one control device coupled to the road wheel actuator and the hand wheel actuator. The method includes at least the following operations. First, a vehicle speed is received or determined by the control device. A wheel angle limit of steerable road wheels of the vehicle is determined by the control device based on at least the vehicle speed. A wheel angle target for the steerable road wheels is received by the control device. An adjusted wheel angle target is determined by the control device when the wheel angle target corresponds to a wheel angle of the steerable road wheels that is greater than the determined wheel angle limit. The adjusted wheel angle target is limited based on the wheel angle limit. Finally, a control signal is provided to the road wheel actuator by the control device. The control signal generated by the control device to the actuator is based on the wheel angle target or the adjusted wheel angle target, depending on whether the wheel angle target corresponds to a wheel angle of the steerable road wheels that is greater than the determined wheel angle limit.

The method is based on the knowledge that a SBW steering system can be used to increase the possible parameter space of the rack and pinion path depending on the driving situation. A wheel angle limit is determined based on the vehicle speed. The wheel angle limit is used to limit the wheel angle target, regardless of the mechanical end stops or a tolerance range required by previous approaches. This allows the mechanical end stops to be moved outwards (e.g., a larger wheel angle range can generally be considered). The steerable road wheels can therefore take on wheel angles at least for some vehicle speeds that are unattainable according to previous approaches. This increases the functionality of the SBW steering system. For example, a smaller turning radius can be achieved depending on the vehicle's speed. By limiting the wheel angle target based on the determined wheel angle limit, error conditions of the SBW steering system, such as contact with the body by the steerable road wheels are prevented. As a result, the steering wheel position, the rack and pinion position and the associated steering feel can be implemented consistently.

According to one aspect, some examples of the disclosure relate to a SBW steering system for a vehicle. The SBW steering system includes at least one road wheel actuator, one hand wheel actuator and one control device coupled to the road wheel actuator and the hand wheel actuator. The control device is configured to receive or determine a vehicle speed, determine a wheel angle limit of steerable road wheels of the motor vehicle based on at least the vehicle speed, receive a wheel angle target for the steerable road wheels, determine an adjusted wheel angle target, provided that the wheel angle target corresponds to a wheel angle of the steerable road wheels that is greater than the determined wheel angle limit. The adjusted wheel angle target is limited based on the wheel angle limit. The control device is further configured to output a control signal to the road wheel actuator. The control signal generated by the control device to the actuator is based on the wheel angle target or the adjusted wheel angle target, depending on whether the wheel angle target corresponds to a wheel angle of the steerable road wheels that is greater than the determined wheel angle limit.

The benefits achieved by the method described herein are also achieved in a corresponding manner by the SBW steering system. In particular, the determination of a speed-dependent wheel angle limit enables the wheel angle target to be limited depending on the driving situation while the range of achievable wheel angles is maximized and optimized depending on the speed of the vehicle.

In some examples, the wheel angle target is based on a steering wheel angle of a steering wheel of the SBW steering system, which is detected by a steering wheel sensor, or a steering wheel angle of the steering wheel specified by a driving control device, or a wheel angle specified by the driving control device, or a steering wheel angle simulated by the control device, depending on whether the respective detected or specified steering wheel angle exceeds a steering wheel angle limit, which is determined by the control device at least based on a steering ratio and the determined wheel angle limit and/or vehicle speed. The simulated steering wheel angle corresponds to the determined steering wheel angle limit.

The wheel angle requirement for the steerable road wheels can therefore be based on the steering wheel angle of the steering wheel or a input by the driving control device. For example, the driving control device can perform autonomous or semi-autonomous driving functionalities and, in this context, specify a steering wheel angle or a wheel angle of the steerable road wheels, which is set by the steering wheel actuator. Based on the autonomous or semi-autonomous driving functionality, the vehicle can therefore be guided by the higher-level driving control device according to a self-specified trajectory, also regarding the vehicle’s lateral guidance. In addition, however, the control device determines a steering wheel angle limit, for example depending on the vehicle speed and/or the determined wheel angle limit, considering the steering ratio. If the detected steering wheel angle or the specified steering wheel angle exceeds the steering wheel angle limit, the control device simulates a steering wheel angle that corresponds to the determined steering wheel angle limit. The determined steering wheel angle limit cannot therefore be exceeded regarding the wheel angle requirement, but it can be exceeded regarding the actual steering wheel position. This effectively limits the parameter space for the wheel angle target, which corresponds to the limitation of the wheel angle target. This generally ensures consistent control between the wheel angle target and the steering wheel angle.

In the scenario where the driving control device directly dictates a wheel angle of a steerable road wheel, the control device still determines a wheel angle limit of the steerable road wheels based on at least the vehicle speed. The determined wheel angle limit is also considered by the control device regarding the determined wheel angle limit. This means that an adjusted wheel angle target is also determined by the control device, provided that the wheel angle requirement (of the driving control device) corresponds to a wheel angle of the steerable road wheels that is greater than the determined wheel angle limit. The adjusted wheel angle target is then limited accordingly based on the wheel angle limit. For example, a control signal is issued to the road wheel actuator by the control device. The control signal is based on the wheel angle target or the adjusted wheel angle target, depending on whether the wheel angle target corresponds to a wheel angle of the steerable road wheels that is greater than the determined wheel angle limit. However, in this example, the steering wheel can be moved less relative to the steerable road wheels. This means that a modified steering ratio is used. Ultimately, the steering wheel can also be kept still, as the driving control device exerts lateral control of the vehicle. In this case, it may not be necessary to determine the steering wheel angle, as the steering wheel is rotated less or in some examples not at all.

In some examples, a dynamic steering wheel end stop by the steering wheel actuator is simulated by a feedback torque applied at least indirectly to the steering wheel, provided that the respective detected or specified steering wheel angle of the steering wheel exceeds the determined steering wheel angle limit. The feedback torque for the simulated dynamic steering wheel end stop can be particularly high, making it difficult for the driver to surpass. This effectively prevents the driver from steering into the area according to which the wheel angle input is already overridden by the simulated wheel angle input.

The simulated dynamic end stop is also known as the dynamic end stop (DES) function, according to which the steering wheel end stop is simulated at the DES position. The DES position corresponds to the determined steering wheel angle limit, which is the basis for the simulated steering wheel end stop When the detected or specified steering wheel angle exceeds the determined steering wheel angle limit, a steering wheel angle is simulated for the wheel angle requirement that corresponds to the determined steering wheel angle limit. At the position of the steering wheel angle limit (e.g., the DES position) a feedback torque is then initiated, which is output to the steering wheel, also known as the DES feedback torque. The DES feedback torque is particularly high to prevent the driver from deflecting the steering wheel beyond the determined steering wheel angle limit.

According to one aspect, the determined steering wheel angle limit for the simulated dynamic steering wheel end stop can be maintained regardless of a change in the determined wheel angle limit and/or the vehicle speed until the respective detected or specified steering wheel angle limit falls below the retained determined steering wheel angle limit. The simulated dynamic steering wheel end stop is only applied if the steering wheel angle limit is previously exceeded by the detected or the specified steering wheel angle. In general, a change in vehicle speed or a change in the wheel angle limit can mean that the steering wheel angle limit should change. However, the previously determined and applied steering wheel angle limit is maintained constant until the detected or specified steering wheel angle, depending on the one applied at the time of control, falls below the previously determined and applied steering wheel angle limit in the direction of the permitted steering wheel angle. This can prevent inconsistent control states of the SBW steering system.

In some examples, preference is given to an offset caused by the retained determined steering wheel angle limit with simultaneous change in the determined wheel angle limit and/or the vehicle speed, continuously degraded within a specified period of time or over a steering wheel angle interval, provided that the respective detected or specified steering wheel angle is below the retained determined steering wheel angle limit. A change in vehicle speed or a change in the wheel angle limit may mean that the steering wheel angle limit should change, although it will be maintained, as explained earlier. This generally causes an offset between the determined and constantly applied steering wheel angle limit and the steering wheel angle limit that is appropriate at the time of control. This offset is reduced as described when the detected or specified steering wheel angle falls below the constantly applied steering wheel angle limit.

In some examples, the control device determines the steering wheel angle limit based on a lookup table and/or algorithm. In some examples, the control device determines the wheel angle limit based on a lookup table and/or algorithm. In some examples, an algorithm can be used to ensure adjustments and higher resolutions of the control behavior during operation, for example depending on variable parameters.

In some examples, when determining the wheel angle limit, the control device considers at least one of a change in the longitudinal speed of the vehicle, a change in the transverse speed of the vehicle and/or a vertical cycle path of at least one road wheel of the vehicle. This allows various parameters to be considered to have an influence on the lateral control of the vehicle. This increases the precision of the wheel angle limit regarding the respective vehicle characteristics.

In some examples, the vehicle includes at least one wheel speed sensor. The wheel speed sensor detects a wheel speed of at least one road wheel in the circumferential direction. The control device determines the vehicle speed at least based on the detected wheel speed or receives the vehicle speed determined on the basis of the detected wheel speed. The control device can determine and consider, for example, the wheel-specific slippage on the basis of the recorded wheel speeds. In some examples, the vehicle can also include several wheel speed sensors, which record, for example, the wheel speeds of different road wheels. In this way, an average vehicle speed can be determined. By determining the wheel-specific slippage, the vehicle condition of the vehicle can be precisely characterized by the control device. For example, the vehicle can also be characterized with regard to its prevailing speed change values at a specific point in time (e.g., the speed change values in the longitudinal direction of the motor vehicle) in the transverse direction of the motor vehicle, and in the lateral direction of the vehicle. In addition or alternatively, the SBW steering system may have a pinion sensor that is configured to detect a force applied by a road wheel actuator to a pinion to which the steerable road wheels are at least indirectly coupled. These parameters, such as the wheel-specific slip and the force exerted by the road wheel actuator, are then considered by the control device, for example when determining a feedback torque input of a feedback torque to be applied to the steering wheel by the hand wheel actuator to give the driver of the vehicle a feeling for the lateral control of the vehicle.

In some examples, the control device determines the wheel angle limit in such a way as to prevent contact between a road wheel and a body of the vehicle, considering a tolerance distance. The tolerance distance from the control device can in some examples be variably determined based on the vehicle speed of the vehicle. While a short tolerance distance is sufficient for low vehicle speeds, a larger tolerance distance can be selected for higher vehicle speeds. In this way, the available wheel angle range can be optimally used for lateral control of the motor vehicle.

Alternatively or additionally, the control device determines the wheel angle limit in such a way that a wheel angle range of wheel angles of the steerable road wheels, which is limited by the determined wheel angle limit, is shorter than a mechanical wheel angle range of wheel angles of the steerable road wheels defined by mechanical end stops. This prevents stress on the mechanical end stops to limit the wheel angles, which can increase service life. In addition, tolerance ranges can also be considered in the event of production fluctuations and fluctuations in the number of units, for example.

The road wheel actuator is at least indirectly coupled with a steerable road wheel. In some examples, the road wheel actuator can also be coupled at the same time, at least indirectly, with several steerable road wheels, for example via a rack of the SBW steering system. As an alternative, the vehicle may also include at least a second road wheel actuator, which can be coupled, for example, to steerable rear wheels of the vehicle, for example via an additional rack of the SBW steering system. The multiple road wheel actuators can be controlled together by the control device. Each road wheel actuator has an electric motor to apply torque to change the orientation of the steerable road wheels. As an example, the road wheel actuator can apply the torque to the rack to adjust the rack position as required. For example, the electric motor can have a winding set with three windings (e.g., a three-phase winding set). Alternatively, the electric motor can also have more winding sets.

The hand wheel actuator is configured to apply feedback torque to the steering wheel, at least indirectly, for example via a steering column coupled to the steering wheel. The feedback torque caused by the hand wheel actuator is also used to provide the driver torque feedback via the vehicle's lateral guidance. In general, the hand wheel actuator includes an electric motor to apply the feedback torque to the steering wheel. For example, the electric motor can include a winding set with three windings (e.g., a three-phase winding set). Alternatively, the electric motor can also include more winding sets.

The control signal output by the control device to the road wheel actuator can be analog or digital. The road wheel actuator uses the received control signal to determine a torque that it outputs from its electric motor so that the wheel angle of the steerable road wheels best matches the wheel angle input or the adapted wheel angle target. The limitation of the adjusted wheel angle input by the wheel angle limit corresponds to a input of limit values for the control signal that cannot be exceeded. This means that the parameter space available for the control signal is effectively limited or at least adjusted, which is considered by the road wheel actuator when determining the torque required to change the wheel angle of the steerable road wheels. This has the advantage that the intrinsic control of the road wheel actuator does not have to be changed.

The steering ratio corresponds to a ratio between the respective steering wheel positions of the steering wheel of the SBW steering system and the wheel angles of the steerable road wheels. In some examples, the steering ratio does not have to be constant over the entire parameter space (e.g., over the available range of steering wheel angles limited by the steering wheel angle limit or over the range of the achievable wheel angles limited by the wheel angle limit). Rather, the steering ratio can have a variable gear ratio.

In some examples, the method can be further implemented by receiving or determining a detected wheel angle of the steerable road wheels of the motor vehicle by the control device. The wheel angle can be detected by wheel angle sensors. Based on the detected wheel angle of the steerable road wheels, the control device can determine a feedback torque input that corresponds to a feedback torque that is to be output to the steering wheel by the steering wheel actuator, at least indirectly. This provides the driver with a feeling about the lateral control of the vehicle.

In some examples, the control device can output a steering wheel control signal to the hand wheel actuator based on the determined feedback torque to be output, which it uses to adjust the output feedback torque according to the feedback torque input. In some examples, the control device determines the feedback torque input, at least also based on the variable steering ratio. This allows the situational characteristics of the SBW steering system to be considered, resulting in a consistent steering feel. In some examples, the control device determines the feedback torque input based on a lookup table and/or algorithm.

In some examples, the wheel angle limit can refer to a rack and pinion travel limit, according to which a rack travel of a rack of the SBW steering system is limited. The rack and pinion travel limit is determined by the control device depending on the vehicle speed. For example, the wheel angle requirement refers to a rack and pinion position requirement that is adjusted by the control device, provided that the rack and pinion position requirement corresponds to a rack position that is outside the rack travel limit. So the adjusted rack position requirement is limited by the rack and pinion travel limit. The actuator output to the road wheel actuator then corresponds to the rack and pinion position requirement or the adjusted rack and pinion position requirement. In this case, a rack and pinion sensor can be used to detect a position of the rack. Based on the position of the rack, the control device can determine a feedback torque requirement that is appropriate to the situation. In addition, the rack and pinion travel can be considered by the control device when determining the steering wheel angle limit.

According to a further aspect, the disclosure also relates to a computer program product, comprising commands which, when executed by a computer, cause the computer to execute the method as described herein. The benefits achieved by the process described herein are also achieved in a corresponding manner by the computer program product. According to an additional aspect, the disclosure also relates to a non-transitory computer-readable storage medium, comprising commands which, when executed by a computer, cause the computer to execute the method as described herein. The advantages achieved by the process described herein are also achieved in a corresponding way by the non-transitory computer-readable storage medium.

According to another aspect, some examples of the disclosure relate to a vehicle including a SBW steering system as described herein. The advantages achieved by the SBW steering system described herein are also achieved in a corresponding way by the vehicle.

For the purposes of the disclosure, vehicles may include, in particular, land vehicles, namely, inter alia, off-road and road vehicles such as passenger cars, buses, trucks, and other commercial vehicles. Vehicles can be manned or unmanned. The vehicles can at least partially electrically driven (e.g., have an electric motor that serves as the drive). In addition, the motor vehicles can also include a combustion engine. All the features explained regarding the various aspects can be combined individually or in (sub-)combination with other aspects.

The detailed description below, in conjunction with the accompanying drawings, in which the same numbers refer to the same elements, is intended as a description of different examples of the disclosed object and is not intended to represent the only examples. Each example described in this disclosure is intended only as an example or illustration and should not be construed as favored or advantageous over other examples. The illustrative examples contained herein do not claim to be exhaustive and do not limit the claimed subject matter to the exact disclosed forms. Variations of the examples described herein are readily recognizable to the skilled person and the general principles defined herein can be applied to other examples and applications without departing from the spirit and scope of the examples described herein. Therefore, the examples described are not limited to the examples shown but have the widest possible scope of application that is compatible with the principles and characteristics disclosed here.

All the features disclosed below in relation to the examples and/or accompanying figures may be combined, alone or in any sub-combination, with features of the aspects of disclosure, including features of preferred examples, provided that the resulting combination of features is reasonable to a skilled person in the field of technology.

For the purposes of disclosure, the phrase "at least one of A, B and C" means, for example, (A), (B), (C), (A and B), (A and C), (B and C) or (A, B and C), including all other possible combinations if more than three elements are listed. In other words, the term "at least one of A and B" generally means "A and/or B", namely "A" alone, "B" alone or "A and B".

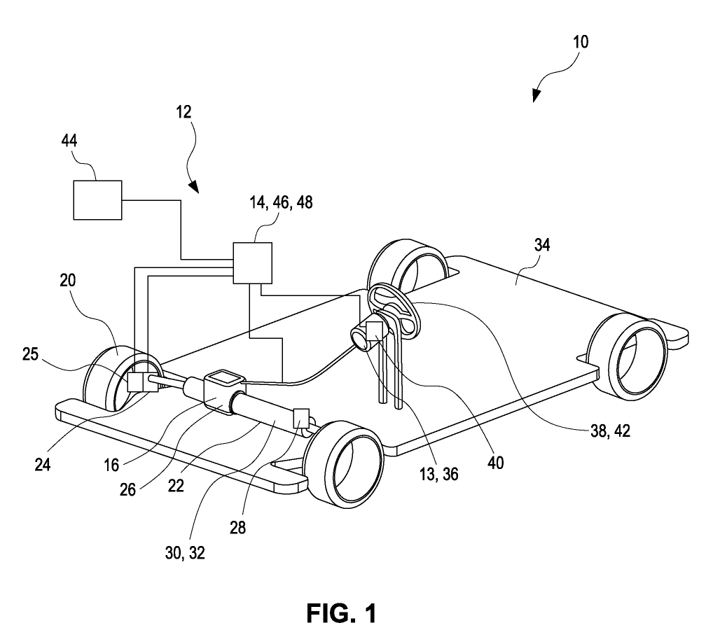

FIG. 1 shows a schematic representation of a vehicle 10 including a SBW steering system 12. The SBW steering system 12 includes a control device 14, a road wheel actuator 16 and a hand wheel actuator 18. The road wheel actuator 16 is indirectly coupled with steerable road wheels 20 of the vehicle 10. For this purpose, the road wheel actuator is coupled with a rack 22, which is coupled to the steerable road wheels 20 of the vehicle 10. The vehicle 10 also includes wheel speed sensors 24, which are coupled to the road wheels 20 and are configured to detect a speed of the road wheels 20 in the circumferential direction and transmit it to the control device 14. Based on the recorded speeds, for example, the wheel-specific slippage can be determined, which enables the characterization of the vehicle 10 according to the respective driving situation. Typically, each road wheel 20 includes a wheel speed sensor 24 assigned to it.

In some examples, the SBW steering system 12 includes at least one wheel angle sensor 25 or is at least indirectly coupled with it. The wheel angle sensor 25 detects a wheel angle of at least one steerable road wheel 20 around the wheel angle axis. The detected wheel angle can be considered by the control device 14, for example, when determining the feedback torque input.

In some examples, the SBW steering system 12 includes a rack and pinion sensor 26, which is integral with the road wheel actuator 16. The rack and pinion sensor 26 is configured to detect a rack position of the rack 22, for example in relation to a reference position. Based on the rack position, the control device 14 can also determine the wheel angle of the steerable road wheels 20. In some examples, the SBW steering system 12 can also include a pinion sensor that detects corresponding measurement variables based on which the steering angle of the steerable road wheels 20 can be determined by the control device 14.

In addition, the SBW steering system 12 includes mechanical end stops 28, which are configured in relation to the rack 22. This means that the rack 22 can only be deflected by the road wheel actuator 16 until the rack 22 meets the mechanical end stops 28. In some examples, mechanical end stops 28 are provided for both opposite ends of the available rack and pinion travel. For example, a maximum mechanical rack travel 30 is defined by the mechanical end stops 28. The maximum mechanical rack and pinion travel 30 thus limits the range of achievable steering angles of the steerable road wheels 20.

In some examples, the control device 14 is configured to limit the steering angle of the steerable road wheels 20. For example, the control device 14 can consider a wheel angle limit 32, by which the range of achievable wheel angles of the steerable road wheels 20 can be influenced and limited depending on the situation. In some examples, the wheel angle limit of 32 can be generated by a corresponding rack and pinion position limit (or a corresponding pinion position limit). As a result, the range of the achievable wheel angles of the steerable road wheels 20 is limited by the control device 14. Because the wheel angle limit 32 depends on the vehicle speed, the control device 14 can offset the mechanical end stops 28 in such a way that, after adjustment, a wider range of achievable steering angles of the steerable road wheels 20 is enabled. The driving situation limitation depending on the driving speed is ensured by the wheel angle limit of 32.

The SBW steering system 12 also includes a steering wheel 34, to which the steering wheel actuator 18 is at least indirectly coupled, for example via a steering column. The steering wheel actuator 18 is configured to exert feedback torque on the steering wheel 34 so that the driver of the vehicle 10 is given a feeling about the lateral guidance of the vehicle 10.

The steering wheel actuator 18 includes an electric motor. The electric motor of the steering wheel actuator 18 includes at least one winding set. Each winding set of the electric motor is three-phase and configured to drive a rotor of the electric motor. As a result, feedback torque can be provided to the driver on the steering wheel 34 of the vehicle 10 by the electric motor to give the driver a feeling about the lateral control of the vehicle 10 or to ensure lateral control autonomously or semi-autonomously.

Using the steering wheel 34, a driver of the vehicle 10 can provide steering inputs for the vehicle 10. In some examples, the SBW steering system 12 includes at least one steering wheel sensor 36, which is configured to detect a steering wheel angle (e.g., a steering wheel position) of the steering wheel 34 in relation to a reference position, for example a zero position. The steering wheel 34 can be deflected according to a permissible maximum steering wheel 38. The measured steering wheel angle generally defines a wheel angle requirement for the wheel angle of the steerable road wheels 20.

In some examples, the steering wheel sensor 36 is integral with the hand wheel actuator 18. In other examples, however, the steering wheel sensor 36 can also be separate from the hand wheel actuator 18. The steering wheel sensor 36 is configured to transmit the detected steering wheel angle to the control device 14. The permissible maximum steering wheel 38 of the steering wheel 34 is also limited by the mechanical end stops 40.

In some examples, the control device 14 is configured to determine a steering wheel angle limit of 42, which is used to simulate a steering wheel angle that is used for the wheel angle target if the detected steering wheel angle exceeds the steering wheel angle limit of 42. The steering wheel angle limit 42 depends on the vehicle speed. Although this does not generally limit the range of achievable steering wheel angles of the steering wheel 34, actual steering wheel angles outside the steering wheel angle limit 42 have no effect on the control of the steering angles of the steerable road wheels 20. In addition, if the steering wheel angle limit 42 is exceeded, a high feedback torque can be caused on the steering wheel 34, which is exerted by the hand wheel actuator 18. This makes it more difficult for the driver to deflect the steering wheel 34 further, thus reducing the load on the mechanical end stops 40.

The control device 14 includes a data processing device. In some examples, when issuing the control signal to the road wheel actuator 16, the control device 14 can consider other parameters of the vehicle 10, such as vehicle speed or speed change values. In some examples, these values can also be considered when regulating the feedback torque applied to the steering wheel 34 by the hand wheel actuator 18. In some examples, the SBW steering system 12 can include several components of the same type and generally the same function, for example several steering wheel sensors 36, which ensures redundancy.

In some examples, the vehicle 10 includes a driving control device 44 which is configured to perform autonomous or semi-autonomous driving functions. For example, the driving control device 44 can autonomously cause lateral guidance of the vehicle 10 in this way. For this purpose, the driving control device 44 may, for example, specify a steering wheel angle of the steering wheel 34 or a wheel angle of a steerable road wheel 20, which is then considered as a wheel angle target by the control device 14, provided that it does not exceed the steering wheel angle limit 42.

In the illustrated example, the SBW steering system 12 is depicted as including front-axle steering. The vehicle 10 and the SBW steering system 12 can also in some examples, have other steerable road wheels 20, such as rear wheels coupled to an additional common road wheel actuator 16. Each road wheel actuator 16 includes an electric motor. The electric motor includes at least one winding set that includes a group of windings. Each winding set is configured so that phase currents are configured in the underlying windings when supplied with supply signals, such as phase voltages, which can be used to drive a rotor of the electric motor. The rotor can then be coupled with a corresponding component of the SBW steering system, such as the rack 22, thus enabling the movement of the steerable road wheels 20. In general, the electric motor can also include more than one winding set.

In some examples, each winding set is three-phase, so that the electric motor is configured as a whole at least three-phase, in some examples also six-phase or nine-phase. If there are several winding sets, the winding sets allow the rotor of the electric motor to move independently of other winding sets. This means that the winding sets are separate from each other.

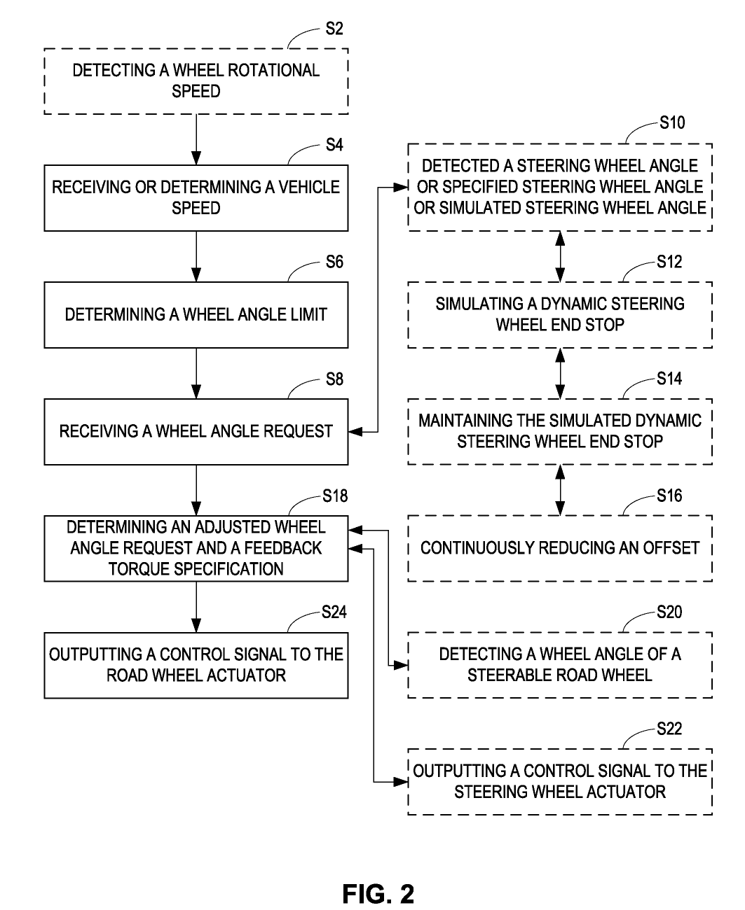

FIG. 2 is a flowchart representative of example machine readable instructions and/or example operations that may be executed, instantiated, and/or performed by example programmable circuitry to implement the SBW steering system 12 of FIG. 1. Optional operations are shown in dashed form. According to the optional operation S2, at least one wheel speed sensor 24 is used to detect a wheel speed of at least one road wheel 20 in the circumferential direction and transmit it to the control device 14.

In the subsequent operation S4, the vehicle speed is received or determined by the control device 14. The control device 14 determines the vehicle speed of the vehicle 10 based on the received wheel speeds. In some examples, the wheel speeds of different road wheels 20 can be considered. In addition, the recording of wheel speeds enables the determination of the wheel-specific slip for each road wheel 20 by the control device 14. Alternatively, the vehicle 10 may also include a speed sensor which is configured to directly detect the vehicle speed of the vehicle 10 and transmit it to the control device 14.

The method then includes operation S6, in which the control device 14 determines a wheel angle limit 32 of the steerable road wheels 20 based on at least the vehicle speed. The wheel angle limit of 32 is thus adapted to the respective vehicle speed and independent of tolerance ranges with regard to mechanical end stops 28.

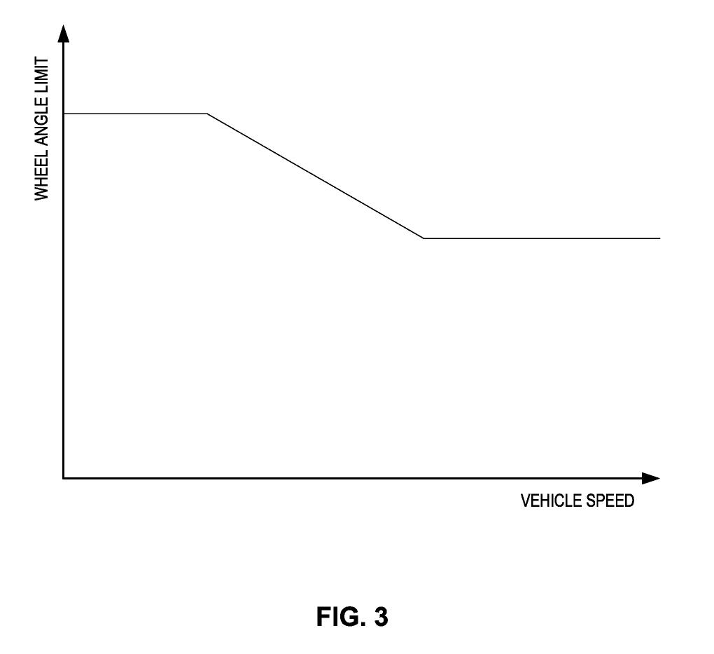

The wheel angle limit 32 is dependent on the vehicle speed such that the wheel angle limit 32 decreases as vehicle speed increases. For example, a greater wheel angle limit 32 is provided at lower vehicle speeds, and a reduced wheel angle limit 32 is provided at higher vehicle speeds. This is shown as an example in FIG. 3, which is a schematic representation of the wheel angle limit 32 as a function of the vehicle's speed (x-axis). On the y-axis, the wheel angle limit 32 determined by the control device 14 is indicated. This considers the fact that the available range of wheel angles can be optimally used for vehicle configurations with low vehicle speeds.

In some examples, the wheel angle limit 32 is determined as a function of vehicle speed such that the allowable wheel angle increases as vehicle speed increases. For example, a smaller wheel angle limit 32 is provided at lower vehicle speeds, and a greater wheel angle limit 32 is provided at higher vehicle speeds. For example, the wheel angle limit 32 can include a smaller value when the vehicle 10 is stationary as compared to when the vehicle 10 has a low vehicle speed. In some examples, the wheel angle limit of 32 can also be constant for specific ranges of vehicle speed.

In some examples, the wheel angle limit 32 can be represented by a limit for the rack and pinion travel, depending on the variable on which the wheel angle of the steerable road wheels 20 is adjusted. In other words, the control mechanism described can be correspondingly configured regarding the rack 22 and corresponding limit values.

In the subsequent operation S8, the control device 14 receives a wheel angle request for the steerable road wheels 20. Operation S8 can be further implemented in various ways by the optional operations S10 to S16.

According to the optional operation S10, the wheel angle requirement received in operation S8 from the control device 14 is based on a steering wheel angle of the steering wheel 34 detected by the steering wheel sensor 36, or on a steering wheel angle of the steering wheel 34 specified by the driving control device 44, or on a steering wheel angle of a steerable road wheel 20 specified by the driving control device 44, or on a steering wheel angle simulated by the control device 14. This depends on whether the respective detected or specified steering wheel angle exceeds the steering wheel angle limit 42, which is determined by the control device 14 at least based on a steering ratio and the determined wheel angle limit 32 and/or the vehicle speed. If the steering wheel angle limit of 42 is exceeded, the steering wheel angle simulated by the control device 14 is used for the wheel angle target from operation S8. The simulated steering wheel angle corresponds to the determined steering wheel angle limit of 42.

In addition, the optional operation S12 may be implemented, in which the hand wheel actuator 18 simulates a dynamic steering wheel deflection based on a feedback torque applied at least indirectly to the steering wheel 34, provided that the respective detected or specified steering wheel angle of the steering wheel 34 exceeds the determined steering wheel angle limit 42. The feedback torque for simulating the dynamic steering wheel kick is particularly high, so it is difficult for the driver to exceed. The simulation of the dynamic end stop by the hand wheel actuator 18 can be initiated by a control signal from the control device 14.

In accordance with the following optional operation S14, the steering wheel angle limit 42 for the simulated dynamic steering wheel end determined in the optional operation S10 is maintained regardless of a change in the determined wheel angle limit 32 and/or a change in vehicle speed, although these changes would actually cause a change in the steering wheel angle limit 42 until the respective detected or specified steering wheel angle limit exceeds the maintained determined steering wheel angle limit 42. For example, once the dynamic steering wheel end stop simulation is initiated, based on a specific determined steering wheel angle limit 42, this setting is maintained without changing the steering wheel angle limit 42 until the simulated dynamic steering wheel end stop is below the allowed steering wheel angle values.

In the optional operation S14, an offset can occur between the determined steering wheel angle limit 42, which is used for the simulated dynamic steering wheel end stop, and a steering wheel angle limit 42, which should be applied due to a change in the determined wheel angle limit 32 and/or a change in vehicle speed. In accordance with the optional operation S16, this offset is continuously reduced within a steering wheel angle range or within a specified period of time, in accordance with the optional operation S16, after the simulated dynamic steering wheel end stop has been exceeded within a steering wheel angle range or within a specified period of time. This prevents discontinuous steering behavior of the SBW steering system 12.

According to operation S18, following operation S8, an adjusted wheel angle requirement is determined by the control device 14 if the wheel angle requirement from operation S8 corresponds to a wheel angle of the steerable road wheels 20 that is greater than the determined wheel angle limit 32. The adjusted wheel angle requirement is limited by the control device 14 based on the wheel angle limit 32. This allows the wheel angle requirement to be normalized to the speed-dependent wheel angle limit of 32.

In addition, the control device 14 in operation S18 of the method determines a feedback torque input for a feedback torque that is to be applied to the steering wheel 34 at least indirectly by the hand wheel actuator 18. Of course, the simulated dynamic end stop from the optional operation S12 can be considered to adjust the amplitude of the feedback torque input as required.

Furthermore, operation S18 can be further implemented by the optional operation S20. Accordingly, a wheel angle of at least one steerable road wheel 20 is at least indirectly detected by a sensor, for example a wheel angle sensor 25. In some examples, a rack position of rack 22 can be detected by a rack sensor 26 or a pinion position of a pinion that is at least indirectly coupled to the road wheel actuator 16. Because both the pinion and the rack are at least indirectly coupled to the steerable road wheels 20, the wheel angle of the steerable road wheels 20 can be determined equally from all measured values, for example by the control device 14.

Subsequently, according to the optional operation S22, the control device 14 generates a steering wheel actuator signal to the hand wheel actuator 18 based on the feedback torque input determined in operation S18 so that the steering wheel actuator 18 can adjust the output feedback torque on the steering wheel 34 accordingly.

In addition, the method includes operation S24, which follows operation S22. In operation S24, the control device 14 generates a control signal to the road wheel actuator 16. The control signal output to the road wheel actuator 16 is based on the wheel angle requirement or the adjusted wheel angle target, depending on whether the wheel angle target corresponds to a wheel angle of the steerable road wheels 20 that is greater than the determined wheel angle limit 32. If the wheel angle target corresponds to a wheel angle that is greater than the determined wheel angle limit of 32, the adjusted wheel angle target is used and used as the basis for the output control signal. For example, the road wheel actuator 16 can adjust the wheel angle of the road wheels 20 based on the control signal depending on the speed, without having to consider predefined conditions regarding the mechanical end stops 28, such as tolerance ranges.

In some examples, in operation S6 and/or in optional operation S10, the control device 14 can consider lookup tables 46 and/or algorithms 48 for determining the wheel angle limit 32 and/or the steering wheel angle limit 42. In addition, the lookup tables 46 and/or the algorithms 48 can also be considered by the control device 14 in operation S18 when determining the adjusted wheel angle target and/or the feedback torque target and/or when determining the corresponding control signal.

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non- transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/ or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

The wheel angle limit 32 is, in some examples, determined by the control device 14 in operation S6 in such a way that a tolerance distance between a steerable road wheel 20 and a body of the vehicle 10 is generally ensured. Furthermore, the control device 14 can determine the wheel angle limit 32 in such a way that only a wheel angle range is achievable, which is shorter than the wheel angle range defined by the mechanical end stops 28. For example, the load on the mechanical end stops 28 can be kept low and unintentional contact between road wheels 20 and the body of the vehicle 10 can be prevented.

In some examples, additional parameters of the vehicle 10 can also be considered when determining the wheel angle limit 32, the steering wheel angle limit 42, the adjusted wheel angle target and/or the feedback torque target by the control device 14, such as a longitudinal speed change of the vehicle 10, a transverse speed change of the vehicle 10 and/or a vertical cycle path of at least one road wheel 20 of the vehicle 10. , the respective parameters can be tailored to the respective driving situation characteristics of the vehicle 10.

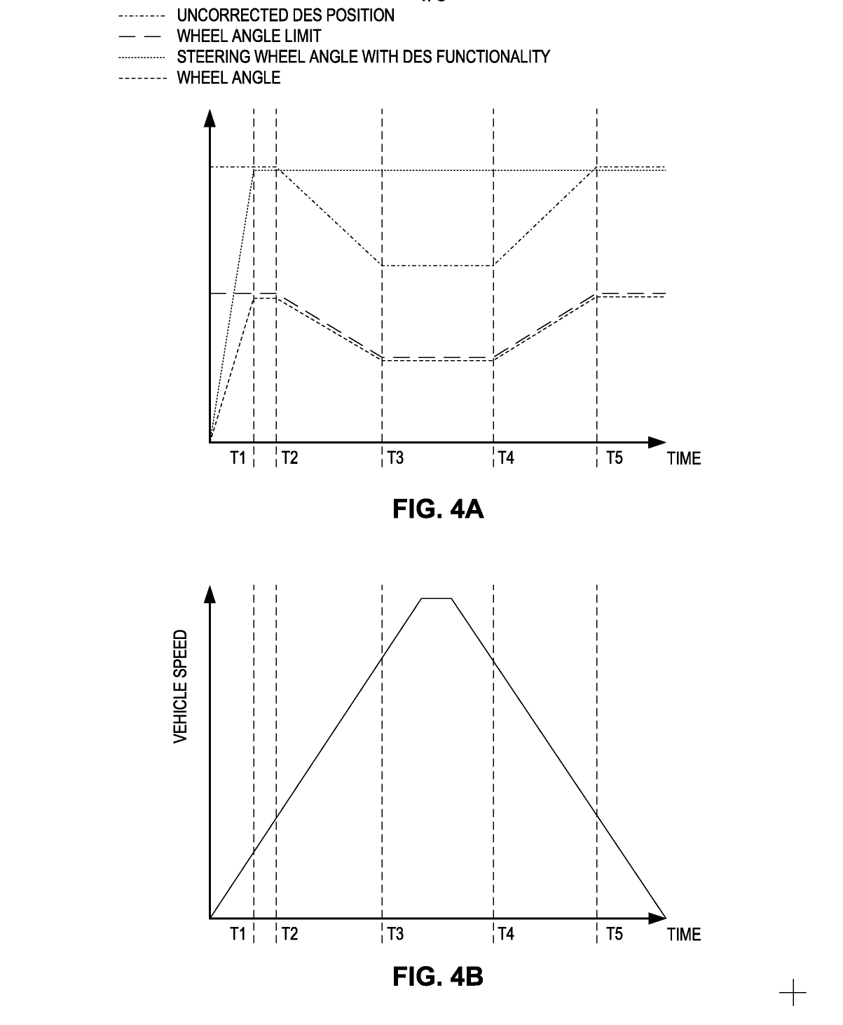

As an example, FIGS. 4A and 4B show schematic representations of the time-dependent courses of various parameters of the SBW steering system 12. Time is plotted on the x-axis. In FIG. 4A, the curves of an uncorrected DES position (e.g., a DES position that does not depend on the vehicle speed), the wheel angle limit 32, the steering wheel angle with DES functionality (e.g., with a DES position that is speed-dependent), and the wheel angle are shown on the y-axis. For better understanding, different dots, dash dots and dashed lines are used. FIG. 4B shows the velocity of the vehicle speed of the vehicle 10.

In FIG. 4A, the wheel angle limit 32 is reduced at time t2 by the control device 14 to time t3 on the basis of the increasing vehicle speed (see FIG. 4B). At time t3, the wheel angle limit 32 is reduced to prevent unwanted configurations of the SBW steering system 12, although the vehicle speed of the vehicle 10 continues to increase. The unwanted configurations may concern, for example, a contact between the steerable road wheels 20 and the body of the vehicle 10.

According to previous approaches, however, the wheel angle limit 32 would have to be limited for all vehicle speeds to the value that the wheel angle limit 32 has here only between the time points t3 and t4 based on the method described. As a result, the parameter space for the respective permissible wheel angle can be increased based on the speed-dependent wheel angle limit 32 for other time periods, in this case: t < t3 and t > t4, compared to previous approaches. This increases the functionality of the SBW steering system 12.

After initial deflection, the wheel angle follows the course from time t1 to the wheel angle limit of 32. Without the extension of the DES function, the driver would be returned to the steering wheel position corresponding to the wheel angle, because the DES position would follow the wheel angle limit 32, as shown in FIG. 4A using the uncorrected DES position (dashed line). This means that for steering wheel positions beyond the DES position, defined by the steering wheel angle limit of 42, and as the vehicle speed increases, the DES position shifts as the wheel angle limit changes to 32. In particular, the DES position shifts inwards. As a result, the driver would experience a high feedback torque through the DES simulation, which would drive him back inwards to the reference position. This is uncomfortable and confusing for the driver. As vehicle speeds drop, the opposite would occur. The DES position would move outwards. In this case, the driver would have to turn further to keep the wheel angle at the wheel angle limit of 32.

The speed-dependent extension of the DES function by the control device 14 enables a consistent steering feel and prevents the driver from experiencing changing DES positions with an inconsistent steering feel. In contrast to previous approaches, the steering wheel angle limit of 42 is maintained if the detected or specified steering wheel angle exceeds the simulated steering wheel angle, which depends on the steering wheel angle limit of 42. For example, within the time interval between time points t2 and t5, in which the driver wants to keep the wheel angle at the wheel angle limit 32 and the vehicle speed still changes, the DES position is kept constant, depending on the steering wheel angle limit 42 determined at time t2. This does not change the steering wheel position of the simulated dynamic steering wheel stop (DES position) for the driver and therefore does not apply an adjusted feedback torque that pushes the driver towards the reference position, at least until the detected or specified steering wheel angle falls below the DES position in the direction of the permitted steering wheel angle values.

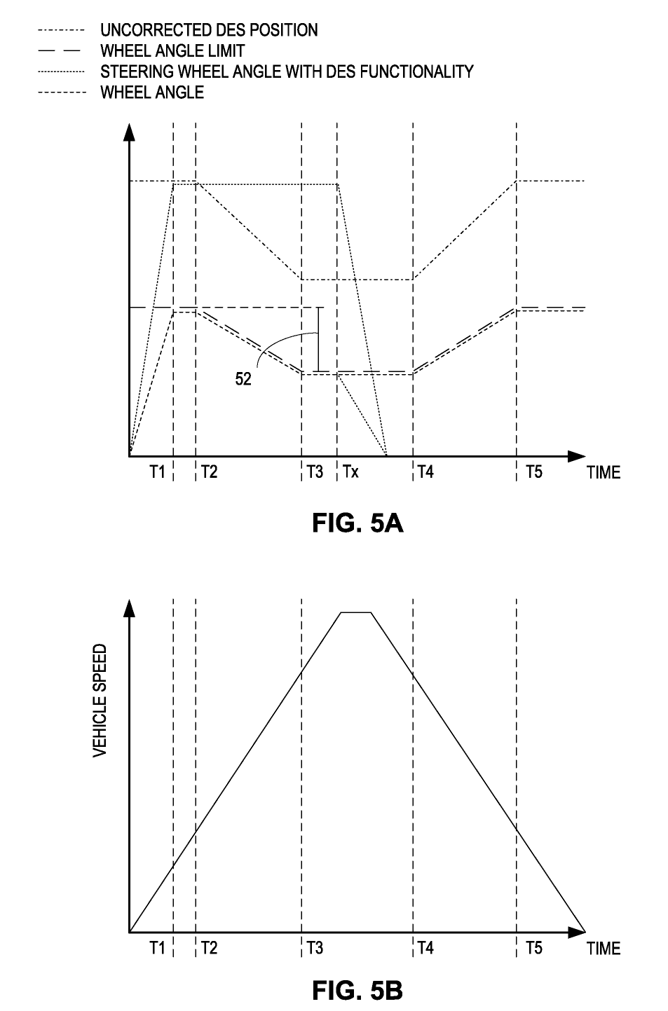

To prevent (abrupt) changes in the steering behavior of the SBW steering system 12 for the driver of the vehicle 10, the control device 14 introduces an offset 52. The offset 52 is the quotient between the steering wheel angle of the steering wheel 34 recorded or specified at a control time divided by the steering ratio applied at that time, from which the wheel angle of the steerable road wheels 20 recorded at the control time is subtracted. In this context, FIGS. 5A and 5B show schematic representations of the consideration of the offset 52 in the context of the time-dependent courses of various parameters of the SBW steering system 12. In this example configuration, the driver steers the steering wheel 34 back to the zero position (e.g., the straight position) at time tx. The offset 52 is introduced by the control device 14 over a predetermined time interval and/or a predetermined steering wheel and/or wheel angle range so that the transition is continuous and smooth for the driver of the motor vehicle. This allows for a consistent steering feel without sudden, noticeable changes. It is advantageous to determine the offset 52 in such a way that the offset 52 is determined at the time of the driver's steering back in the direction of the reference position. Alternatively, the offset 52 can also be described in terms of the steering wheel angle. Then the offset 52 is defined as the value between the steering wheel angle recorded or specified at the control time and the measured wheel angle multiplied by the steering ratio.

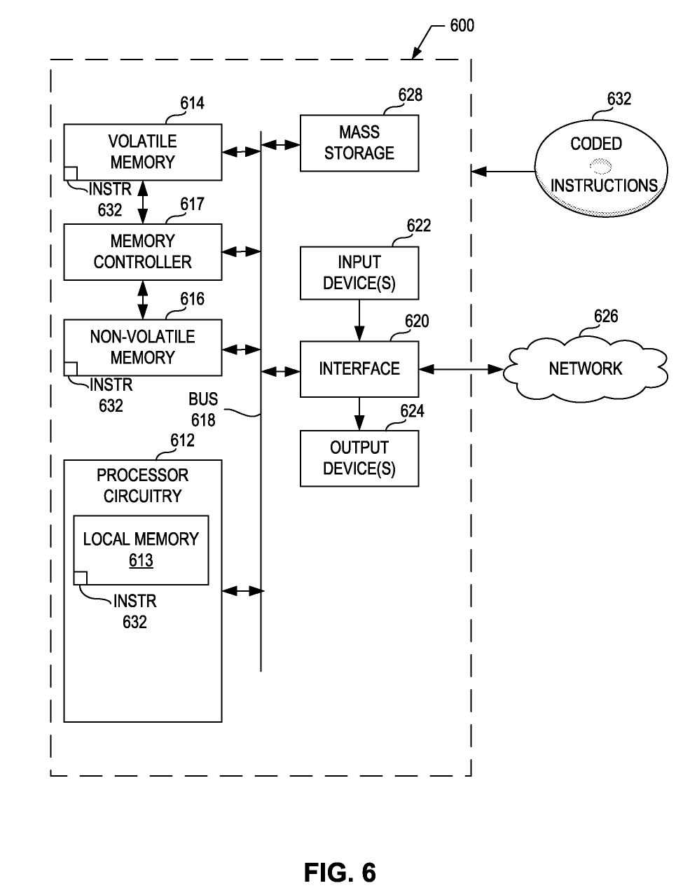

FIG. 6 is a block diagram of an example programmable circuitry platform 600 structured to execute and/or instantiate the example machine-readable instructions and/or the example operations of FIG. 2 to implement examples disclosed herein. The programmable circuitry platform 600 can be, for example, a control device, an electronic control unit (ECU), a self-learning machine (e.g., a neural network), or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 612 may be implemented by one or more semiconductor based (e.g., silicon based) devices.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616. The programmable circuitry platform 600 of the illustrated example also includes interface circuitry 620. The interface circuitry 620 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a button, a touchscreen, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 632, which may be implemented by the machine-readable instructions of FIG. [Flowcharts], may be stored in the mass storage device 628, in the volatile memory 614, in the non-volatile memory 616, and/or on at least one non-transitory computer readable storage medium such as a CD or DVD which may be removable.

This disclosure can refer to quantities and numbers. Unless expressly stated, such quantities and figures are not to be regarded as limiting, but as examples of the possible quantities or figures in connection with the disclosure. In this context, the term "plural" can also be used in this disclosure to refer to a quantity or number. In this context, the term "plural" refers to any number that is greater than one, e.g. two, three, four, five, etc. The terms "approximately", "approximately", "near", etc. mean plus or minus 5% of the stated value.

Although the disclosure has been presented and described in relation to one or more examples, after reading and understanding this description and the accompanying drawings, the skilled person will be able to make equivalent changes and modifications. Further examples and combinations thereof include the following:

Example 1 includes a steer-by-wire (SBW) steering system comprising a road wheel actuator, machine readable instructions, and a controller to execute the machine readable instructions to determine a wheel angle limit of steerable road wheels of a vehicle based on a speed of the vehicle, determine an adjusted wheel target angle based on the wheel angle limit and a wheel target angle associated with the vehicle, and cause the road wheel actuator to steer the steerable road wheels based on the adjusted wheel target angle.

Example 2 includes the SBW steering system of any preceding clause, wherein the adjusted wheel target angle is further determined based on a wheel end stop associated with the vehicle.

Example 3 includes the SBW steering system of any preceding clause, wherein the controller is configured to further determine the adjusted wheel target angle based on a value associated with the wheel end stop, so that the adjusted wheel target angle cannot exceed the value.

Example 4 includes the SBW steering system of any preceding clause, wherein the controller is configured to increase a feedback torque of a hand wheel actuator of the SBW steering system when the wheel target angle is greater than the value.

Example 5 includes the SBW steering system of any preceding clause, wherein the controller is configured to maintain a current adjusted wheel angle target based on the wheel angle limit when the wheel target angle is greater than the value.

Example 6 includes the SBW steering system of any preceding clause, wherein an offset between the current adjusted wheel angle target and an updated adjusted wheel angle target is reduced over a predetermined time when the wheel target angle is less than the value.

Example 7 includes the SBW steering system of any preceding clause, wherein the wheel angle limit includes at least one of a longitudinal speed of the vehicle, a transverse speed of the vehicle, or a vertical movement of at least one road wheel of the vehicle.

Example 8 includes a vehicle comprising steerable road wheels, a road wheel actuator coupled to the steerable road wheels, a hand wheel actuator, and controller circuitry configured to determine a wheel angle limit of the steerable road wheels based on a speed of the vehicle, determine an adjusted wheel target angle based on the wheel angle limit and a wheel target angle associated with the hand wheel actuator, and cause the road wheel actuator to steer the steerable road wheels based on the adjusted wheel target angle.

Example 9 includes the vehicle of any preceding clause, wherein the adjusted wheel target angle is further determined based on a wheel end stop of the vehicle.

Example 10 includes the vehicle of any preceding clause, wherein the controller circuitry is configured to further determine the adjusted wheel target angle based on a value associated with the wheel end stop, so that the adjusted wheel target angle cannot exceed the value.

Example 11 includes the vehicle of any preceding clause, wherein the controller circuitry is configured to increase a feedback torque of the hand wheel actuator when the wheel target angle is greater than the value.

Example 12 includes the vehicle of any preceding clause, wherein the controller circuitry is configured to maintain a current adjusted wheel angle target based on the wheel angle limit when the wheel target angle is greater than the value.

Example 13 includes the vehicle of any preceding clause, wherein an offset between the current adjusted wheel angle target and an updated adjusted wheel angle target is reduced over a predetermined time when the wheel target angle is less than the value.

Example 14 includes the vehicle of any preceding clause, wherein the wheel angle limit includes at least one of a longitudinal speed of the vehicle, a transverse speed of the vehicle, or a vertical movement of at least one of the steerable road wheels.

Example 15 includes a non-transitory computer readable storage medium comprising instructions to cause at least one programmable circuit to determine a wheel angle limit of steerable road wheels of a vehicle based on a speed of the vehicle, determine an adjusted wheel target angle based on the wheel angle limit and a wheel target angle associated with the vehicle, and cause a road wheel actuator of the vehicle to steer the steerable road wheels based on the adjusted wheel target angle.

Example 16 includes the non-transitory computer readable storage medium of any preceding clause, wherein the adjusted wheel target angle is further determined based on a wheel end stop associated with the vehicle.

Example 17 includes the non-transitory computer readable storage medium of any preceding clause, wherein the at least one programmable circuit is to further determine the adjusted wheel target angle based on a value associated with the wheel end stop, so that the adjusted wheel target angle cannot exceed the value.

Example 18 includes the non-transitory computer readable storage medium of any preceding clause, wherein the at least one programmable circuit is to increase a feedback torque of a hand wheel actuator of the vehicle when the wheel target angle is greater than the value.

Example 19 includes the non-transitory computer readable storage medium of any preceding clause, wherein the at least one programmable circuit is to maintain a current adjusted wheel angle target based on the wheel angle limit when the wheel target angle is greater than the value.

Example 20 includes the non-transitory computer readable storage medium of any preceding clause, wherein an offset between the current adjusted wheel angle target and an updated adjusted wheel angle target is reduced over a predetermined time when the wheel target angle is less than the value.

What is claimed is:

1. A steer-by-wire (SBW) steering system comprising:
a road wheel actuator;
machine readable instructions; and
a controller to execute the machine readable instructions to:
determine a wheel angle limit of steerable road wheels of a vehicle based on a speed of the vehicle;
determine an adjusted wheel target angle based on the wheel angle limit and a wheel target angle associated with the vehicle; and
cause the road wheel actuator to steer the steerable road wheels based on the adjusted wheel target angle.

2. The SBW steering system of claim 1, wherein the adjusted wheel target angle is further determined based on a wheel end stop associated with the vehicle.

3. The SBW steering system of claim 2, wherein the controller is configured to further determine the adjusted wheel target angle based on a value associated with the wheel end stop, so that the adjusted wheel target angle cannot exceed the value.

4. The SBW steering system of claim 3, wherein the controller is configured to increase a feedback torque of a hand wheel actuator of the SBW steering system when the wheel target angle is greater than the value.

5. The SBW steering system of claim 3, wherein the controller is configured to maintain a current adjusted wheel angle target based on the wheel angle limit when the wheel target angle is greater than the value.

6. The SBW steering system of claim 5, wherein an offset between the current adjusted wheel angle target and an updated adjusted wheel angle target is reduced over a predetermined time when the wheel target angle is less than the value.

7. The SBW steering system of claim 1, wherein the wheel angle limit includes at least one of a longitudinal speed of the vehicle, a transverse speed of the vehicle, or a vertical movement of at least one road wheel of the vehicle.

8. A vehicle comprising:
steerable road wheels;
a road wheel actuator coupled to the steerable road wheels;
a hand wheel actuator; and
controller circuitry configured to:
determine a wheel angle limit of the steerable road wheels based on a speed of the vehicle;
determine an adjusted wheel target angle based on the wheel angle limit and a wheel target angle associated with the hand wheel actuator; and
cause the road wheel actuator to steer the steerable road wheels based on the adjusted wheel target angle.

9. The vehicle of claim 8, wherein the adjusted wheel target angle is further determined based on a wheel end stop of the vehicle.

10. The vehicle of claim 9, wherein the controller circuitry is configured to further determine the adjusted wheel target angle based on a value associated with the wheel end stop, so that the adjusted wheel target angle cannot exceed the value.

11. The vehicle of claim 10, wherein the controller circuitry is configured to increase a feedback torque of the hand wheel actuator when the wheel target angle is greater than the value.

12. The vehicle of claim 10, wherein the controller circuitry is configured to maintain a current adjusted wheel angle target based on the wheel angle limit when the wheel target angle is greater than the value.

13. The vehicle of claim 12, wherein an offset between the current adjusted wheel angle target and an updated adjusted wheel angle target is reduced over a predetermined time when the wheel target angle is less than the value.

14. The vehicle of claim 8, wherein the wheel angle limit includes at least one of a longitudinal speed of the vehicle, a transverse speed of the vehicle, or a vertical movement of at least one of the steerable road wheels.

15. A non-transitory computer readable storage medium comprising instructions to cause at least one programmable circuit to:
determine a wheel angle limit of steerable road wheels of a vehicle based on a speed of the vehicle;
determine an adjusted wheel target angle based on the wheel angle limit and a wheel target angle associated with the vehicle; and
cause a road wheel actuator of the vehicle to steer the steerable road wheels based on the adjusted wheel target angle.

16. The non-transitory computer readable storage medium of claim 15, wherein the adjusted wheel target angle is further determined based on a wheel end stop associated with the vehicle.

17. The non-transitory computer readable storage medium of claim 16, wherein the at least one programmable circuit is to further determine the adjusted wheel target angle based on a value associated with the wheel end stop, so that the adjusted wheel target angle cannot exceed the value.

18. The non-transitory computer readable storage medium of claim 17, wherein the at least one programmable circuit is to increase a feedback torque of a hand wheel actuator of the vehicle when the wheel target angle is greater than the value.

19. The non-transitory computer readable storage medium of claim 17, wherein the at least one programmable circuit is to maintain a current adjusted wheel angle target based on the wheel angle limit when the wheel target angle is greater than the value.

20. The non-transitory computer readable storage medium of claim 19, wherein an offset between the current adjusted wheel angle target and an updated adjusted wheel angle target is reduced over a predetermined time when the wheel target angle is less than the value.
